(19) United States
(12) Patent Application Publication
(10) Pub. No.: US 2006/0049166 A1
(43) Pub. Date: Mar. 9, 2006

(54) Home appliance with removable decorative elements

(76) Inventors: Augusto Picozza, Boca Raton, FL (US); Tom Guyett, Boynton Beach, FL (US); Gregory Holderfield, Oak Park, IL (US)

Correspondence Address: Lawrence J. Shurupoff;Sunbeam Products, Inc., 2381 Executive Center Drive, Boca Raton, FL, 33431, US

(21) Appl. No.: 10/938,339

(22) Filed: Aug. 25, 2004

(51) Int. Cl. F24C 7/10; F27D 11/00

(52) U.S. Cl. 219/386

(57) ABSTRACT

A home appliance having a casing or housing having one or more sidewalls with at least one of the sidewalls defining a topographical element adapted to removably receive a decorative element.

### BACKGROUND OF THE DISCLOSURE

1. Field of the Invention

This invention relates to removable decorative panels for home appliances, such as toasters.

2. Description of the Related Art

It is known to place decorations on the casings of home appliances, such as shown in U.S. Des. 206,307 for a TOASTER, issued Nov. 22, 1966, to Ernest, R. O. As different people prefer different decorations, an appliance that may be attractive to some may not be attractive to others. As far back as the 1960's inventors sought to solve this problem by providing replaceable casing elements for appliances.

Moore, W. E., U.S. Des. 188,925, issued Sep. 27, 1960, for a DECORATIVE END PANEL FOR AN ELECTRIC TOASTER and Knapp, A. S., U.S. Des. 191,084, issued Aug. 8, 1961, for a DECORATIVE END PANEL FOR A TOASTER OR THE LIKE, each disclose endwalls for a toaster casing having an ornamental shape and design.

Okuda et al., U.S. Pat. No. 3,587,907, issued Jun. 28, 1971, for a BREAD TOASTER, discloses a toaster having replaceable metal sidewalls that slide downward into grooves. Sidewalls with different designs and floral patterns may then be provided by the manufacturer to appeal to a wide range of consumers.

The replaceable elements of the prior art are part of the structure of the casing itself. The result is that these parts are bulky and expensive because they must serve not merely a decorative function, but also the structural function of the appliance casing. Further, such elements may only be interchangeable by the manufacturer rather than the consumer. Removal of such structural elements may expose the interior electronics of the appliance. Therefore, once the consumer has chosen a design off the shelf, the consumer may be unable to change the decorative casing segments as desired.

What is needed are inexpensive removable decorative elements that the consumer can interchange quickly and easily without exposing the inner workings of the appliance.

### BRIEF SUMMARY OF THE DISCLOSURE

The present invention is directed to a home appliance having a casing having one or more sidewalls, wherein at least one of the sidewalls defines a topographical mounting element, and wherein the topographical mounting element is adapted to removably receive a decorative element.

In another aspect of the invention, the appliance is a toaster.

In another aspect of the invention, the topographical element is a decorative element.

In another aspect of the invention, the topographical element is a groove formed in an outer surface of an appliance.

In another aspect of the invention, the topographical element has a plurality of receiving apertures, wherein the receiving apertures are sized and positioned to removably receive mounting pins extending from the decorative element.

In another aspect of the invention, the decorative element is a filler decorative element sized and shaped to fill the topographical element.

In another aspect of the invention, the decorative element is a panel decorative element that covers all or a portion of the sidewall of a home appliance.

### BRIEF DESCRIPTION OF THE DRAWINGS

FIG. 1 is a perspective view of a toaster embodiment of the invention showing two embodiments of decorative elements in exploded view.

FIG. 2 is a perspective view of the embodiment of FIG. 1 without any decorative elements attached.

FIG. 3 is a perspective view of the embodiment of FIG. 1 with a decorative element mounted thereon.

FIG. 4 is a perspective view of the embodiment of FIG. 1 with an alternative decorative element mounted thereon.

### DETAILED DESCRIPTION OF THE PREFERRED EMBODIMENTS

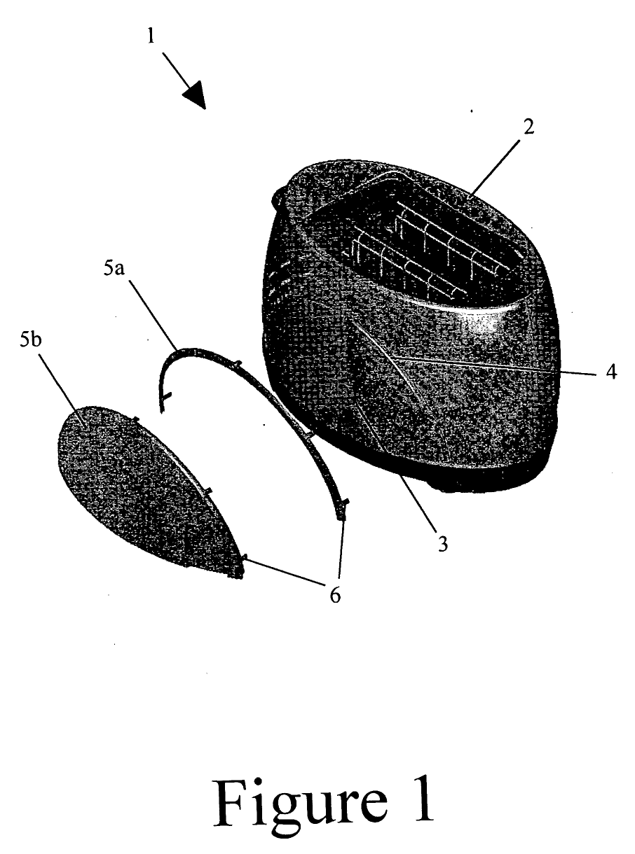

Referring to FIG. 1, there is shown a home appliance 1, in this case an electric toaster, having an outer casing 2, the casing having one or more sidewalls 3. A decorative topographical element 4 is provided, in this case an arcuate groove in the sidewall 3. One or more decorative elements 5a, 5b are provided that removably and interchangeably fit and conform to the topographical element 4.

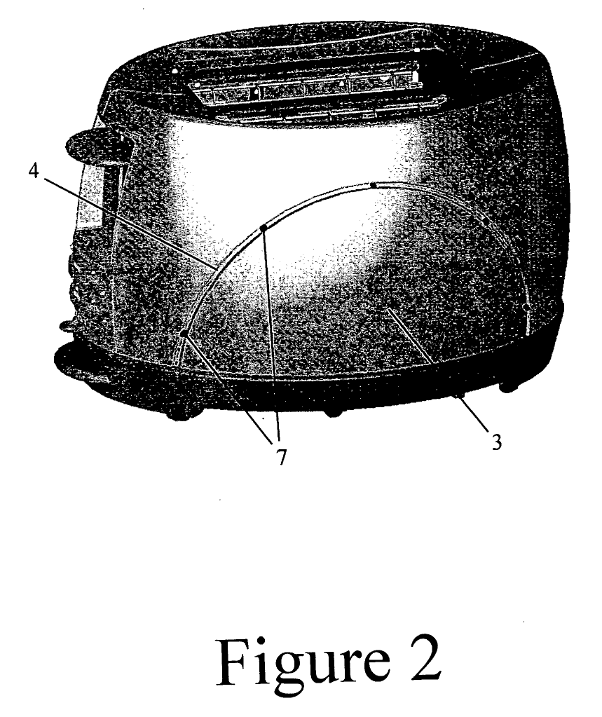

There are a number of ways to removably fit a decorative element 5a, 5b to the topographical element 4. One is to size and shape the topographical element 4 for a snap fit of a correspondingly shaped portion of a decorative element 5. Another is to provide a plurality of mounting pins 6 on the decorative element 5 that fits into receiving apertures 7 (FIG. 2) in the topographical element 4. These mounting pins may be adapted to snap-fit into the receiving apertures 7.

Referring to FIG. 2, there is shown the home appliance of FIG. 1 without any decorative element attached. The receiving apertures 7 can be seen formed within the topographical element 4. In a preferred embodiment, the topographical element is itself decorative in form to account for cases where the consumer prefers not use any of the available decorative elements.

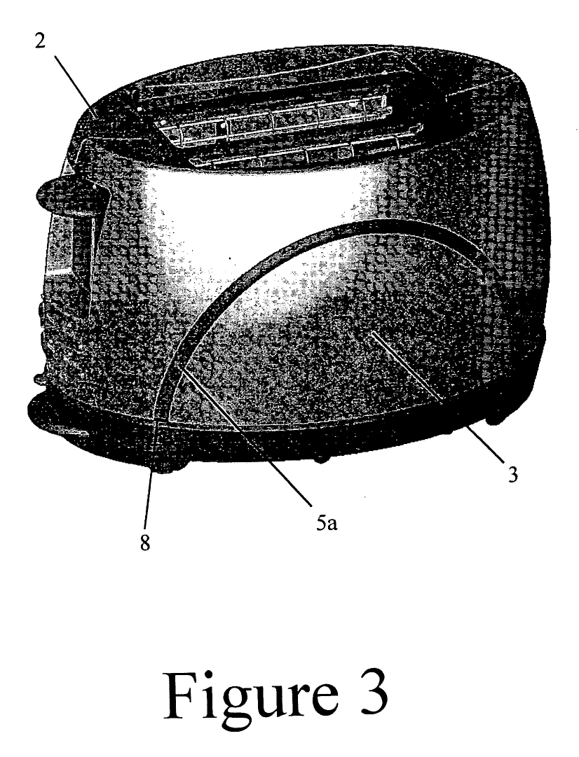

Referring to FIG. 3, there is shown the simplest kind of decorative element, namely a decorative filler element strip or band 5a that simply fills in the topographical element 4 in the sidewall. Filler decorative elements of various colors may be provided to allow the consumer to match the appliance to the color scheme of the household kitchen. It is desirable to provide a very small gap 8 at one or both ends of the filler decorative element so that a tool such as a screwdriver may be slipped under the filler decorative element for removal.

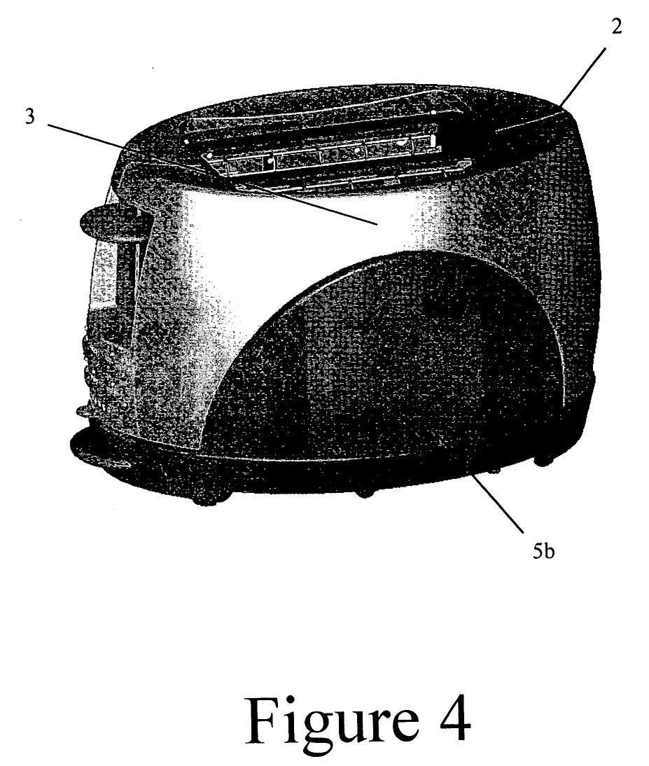

Referring to FIG. 4, there is shown a panel decorative element 5b that fits into the topographical element and covers all or a portion of the sidewall 3. Here, a half-moon shaped portion of the sidewall is concealed by the decorative element 5b. Again, the consumer is preferably provided with a variety of colors to choose from.

While a toaster has been shown as an example, the teachings of this invention are applicable to any home appliance. Further, although a single sidewall is shown, it is anticipated that the opposite side of the appliance not shown in the drawings will preferably have a topographical groove as well, though it is not required that they be identical. Note also that the term “sidewall” as used in this specification is meant to encompass any so-called “end-walls” or top wall or roof as well.

As can be seen, the decorative elements of the invention are inexpensive to produce and easy to replace and may be sold separately in a variety of colors at minimal prices or included with the home appliance. Replacement is easily achieved by the consumer without exposing the interior working components of the appliance.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

1. A home appliance, comprising:
an outer casing having at least one external sidewall defining a topographical element on an exterior portion of said external sidewall; and
a removable decorative element covering at least a portion of said exterior portion, and wherein the topographical element is adapted to removably receive said decorative element.

2. The home appliance of claim 1 wherein the appliance is a toaster.

3. The home appliance of claim 1 wherein the topographical element is decorative.

4. The home appliance of claim 1 wherein the topographical element is a groove.

5. The home appliance of claim 1 wherein the topographical element has a plurality of receiving apertures, wherein the receiving apertures are sized and positioned to removably receive mounting pins on the decorative element.

6. The home appliance of claim 1 wherein the decorative element is a filler decorative element sized and shaped to fill the topographical element.

7. The home appliance of claim 1 wherein the decorative element is a panel decorative element that covers all or a portion of the sidewall.

8. A home appliance having interior components, comprising:
a toaster having an outer casing, the casing having at least one external sidewall defining a decorative topographical element on an external portion of said external sidewall; and
a removable decorative element covering at least a portion of said external sidewall, and wherein the topographical element is a groove adapted to removably receive said decorative element without exposing said interior components.

9. The home appliance of claim 8 wherein the decorative element is a filler decorative element sized and shaped to fill the topographical element.

10. The home appliance of claim 8 wherein the decorative element is a panel decorative element.

11. A home countertop appliance having interior components and comprising:
an outer casing comprising an exterior sidewall extending around said interior components; and
a decorative element removably mounted to said outer casing such that removal of said decorative element from said outer casing does not expose said interior components.

12. The home appliance of claim 11, wherein said decorative element covers a portion of said exterior sidewall.

13. The home appliance of claim 11, further comprising a topographical feature formed in said casing and adapted to removably receive said decorative element.

14. The home appliance of claim 11, further comprising a snap-fit connection between said decorative element and said outer casing.

15. The home appliance of claim 14, wherein said snap-fit connection comprises a plurality of mounting pins.
